(19) United States
(12) Patent Application Publication
(10) Pub. No.: US 2012/0268850 A1
(43) Pub. Date: Oct. 25, 2012

(54) OVERVOLTAGE PROTECTION ELEMENT

(75) Inventors: Durth Rainer, Horn-Bad Meinberg (DE); Christian Depping, Lemgo (DE)

(73) Assignee: Phoenix Contact GMBH & CO KG, Blomberg (DE)

(21) Appl. No.: 13/499,875

(22) PCT Filed: Oct. 1, 2010
(86) PCT No.: PCT/EP2010/064624

§ 371 Date: Jun. 21, 2012

(30) Foreign Application Priority Data
Oct. 2, 2009 (DE) 102009048045.5

(51) Int. Cl. H02H 9/06

(52) U.S. Cl. 361/56

(57) ABSTRACT

An overvoltage protection element includes a housing and at least two electric conductors leading into the housing for the electrical connection of the overvoltage protection element. A surge arrester for limiting an overvoltage of the electric conductors and a pressure-sensitive switch for short circuiting the electric conductors are arranged in the housing. Even with a defective surge arrester, the overvoltage protection element provided thereby reliably and safely short circuits the electric conductors when an arc occurs in the housing, so that an overvoltage protection preferably connected upstream of the overvoltage protection element, for example, a fuse, can be deployed.

### FIELD

The following description relates generally to an overvoltage protection element with a housing and at least two electric conductors leading into the housing for the electrical connection of the overvoltage protection element.

### BACKGROUND

Electric circuits and installations operate in a trouble-free manner with a specified voltage for them, the so-called rated voltage, unless overvoltages occur. Overvoltages are considered to be all voltages that lie above an upper tolerance limit of the rated voltage. This also includes above all transient overvoltages, which can occur due to atmospheric discharges, but also due to switching operations or short circuits in power supply grids can be galvanically, inductively or capacitively coupled into electric circuits. In order now to protect electric or electronic circuits, in particular electronic measuring circuits, control circuits and switching circuits, in a variety of fields of use from transient overvoltages, overvoltage protection elements have been developed, as they have been known for several decades.

The basis of every industrial installation is formed by the lines or conductors of measurement and control technology. The smooth operation of these lines requires a high degree of availability of the transmitted signals. The protective circuits of corresponding overvoltage protection elements must thereby be adapted to the various signal and measurement principles. In particular varistors, suppressor diodes and gas-filled surge arresters or spark gaps as well as combinations of the above-mentioned components are thereby used as surge arresters. The individual surge arresters can thereby be distinguished among other things by the level of the discharge capacity or the protection level. While varistors are generally used as a middle protective stage, gas-filled overvoltage arresters and spark gaps are generally used as coarse protection. Furthermore, the individual surge arresters can be subdivided into voltage-limiting elements, for example, varistors, on the one hand, and voltage-switching elements, for example gas-filled surge arresters and spark gaps, on the other. Varistors in particular are considered below as overvoltage arresters, without the invention being limited thereto.

Surge arresters, in particular varistors and spark gaps, are subject to an aging that changes the rated parameters of the surge arresters. The aging can lead over time, for example, to an undesirable increase of the leakage currents and the subsequent failure of the surge arresters during a discharge operation or also under mains conditions. Surge arresters with a varistor therefore often have a thermal cutoff device, by means of which a varistor that is no longer functioning correctly is cut off from the current path to be monitored. If surge arresters are overloaded during a discharge operation or by temporary overvoltages (TOV), the electrical state into which the surge arrester goes as a rule is not clearly defined. In particular, the impedance of the surge arresters can change such that high mains-operated currents flow through the surge arresters, which are still too low, however, to trigger the upstream overvoltage protection devices. The high power conversion of such an overvoltage protection element that has become low-impedance, heats the component of the overvoltage protection element so quickly that the usual thermal disconnectors are not able to cut off in time and open electric arcs occur. The disconnectors known from the prior art are not designed for high switching capacities either, so that when high currents are already flowing and the disconnector opens, arcs likewise occur that cannot be extinguished. In both cases the arcs can lead to ignition, explosion and/or high pressure buildup that cannot be controlled by the usual plastic housings of the overvoltage protection elements without damage. The result of such arcs is, for example, an inadmissible loss of the IP protection type as well as damage to adjacent assemblies as far as the destruction of the entire industrial installation.

Furthermore, overvoltage protection elements are known from the prior art, in which the surge arrester is encapsulated in a metallic housing such that a fault inside the housing does not permit any inadmissible emissions into the surroundings. Furthermore, with such embodiments, in the event of an overload of the surge arrester, it is to be possible for arcs to develop such that they can be short-circuited by the metallically conducting housing so that the inner energy transformation is minimized and an upstream overvoltage protection, for example, a fuse, can deploy in an accelerated manner. Such overvoltage protection elements therefore assume that in the event of a failure of the encapsulated surge arrester, an arc will occur in the interior of the metallic housing that either extinguishes itself or is extinguished by the reaction of an upstream surge arrester.

However, it is a disadvantage that the behavior of the arc and the effects thereof on the interior installation space of the overvoltage protection element as well as the electrically functional components thereof are undefined and not known. If an arc occurs, metal is melted and evaporated at the base points of the electric arc, so that the metallic enclosure of the overvoltage protection element is permanently mechanically weakened, without this being evident on the overvoltage protection element from outside. The metal vapor caused by the arc is deposited on the inner surfaces of the housing of the overvoltage protection element. If the metal vapor is deposited on insulation materials of the housing, undefined insulation conditions occur. The inner damage is particularly critical when arcs extinguish themselves and do not trigger the upstream overvoltage protection so that inner damage to the overvoltage protection element remains completely unnoticed. It is therefore possible that, even if an upstream overvoltage protection has been triggered, the cause cannot be recognized and the defective or considerably damaged overvoltage protection element will be put into operation again.

The object of the invention is therefore to disclose an overvoltage protection element which in a particularly simple manner ensures a secure cutoff of a fault current even in the case of a faulty surge arrester. This object and others is attained by the various embodiments and features disclosed and claimed below.

### SUMMARY

Accordingly, this object is attained by an overvoltage protection element with a housing and at least two electric conductors guiding into the housing for the electrical connection of the overvoltage protection element, wherein a surge arrester for limiting an overvoltage of the electric conductors and a pressure-sensitive switch for short circuiting the electric conductors are arranged in the housing.

According to the disclosed embodiments, an overvoltage protection element is thus provided, which, even with a defective surge arrester, reliably and safely short circuits the electric conductors with low impedance when an arc occurs in the housing of the overvoltage protection element, so that an overvoltage protection preferably connected upstream, for example, a fuse, can be deployed. This avoids the disadvantages known in the prior art and described above of an arc occurring in the housing of the overvoltage protection element, which can lead to restricted functionality of the surge arrester without this restricted functionality being visible outside the overvoltage element. The invention thus takes a completely new approach that avoids the disadvantages of the prior art listed above.

Increased pressure occurs in the housing due to the arc, so that due to the increased pressure the pressure-sensitive switch, which switches when the pressure increases, short circuits the electric conductors so that the preferably upstream overvoltage protection, for example the fuse, is triggered and switches off a fault current applied at the conductors. The reaction of an overvoltage protection is thus clearly defined so that the risk, as known from the prior art, of a comparatively high-impedance arc leading to a delayed reaction of the overvoltage protection, is ruled out. The arc thus burns only very briefly in the housing and cannot destroy it in the manner that emissions, such as metal vapor, occur. It is likewise advantageous that, due to the short burning duration of the arc, the increase in pressure in the housing occurring due to the arc is reduced such that even small wall thicknesses of the housing are sufficient to control the pressure, which renders possible a cost-effective production of the overvoltage protection element.

In other words, the overvoltage protection element renders possible a particularly safe and simple switching off of a circuit such that, even in the case of a defective surge arrester and the occurrence of an arc in the housing, the pressure developing in the housing due to the arc acts on the pressure-sensitive switch such that the pressure-sensitive switch short circuits the electric conductors so that a preferably upstream overvoltage protection, for example, a fuse, is deployed and switches off the electric circuit or the fault current applied at the conductors. The person skilled in the art will thereby coordinate the pressure-sensitive switch and the volume of the housing with one another such that even arcs with a low capacity or arcs that are only just developing, lead to a reaction, that is, switching, of the pressure-sensitive switch. On the other hand the person skilled in the art will design the overvoltage protection element such that pressure differences in the housing that are generated by heating, fluctuations in the ambient atmosphere and/or typical vibrations of an industrial installation do not lead to a reaction of the pressure-sensitive switch. In particular it is preferred that the pressure-sensitive switch reacts, that is, switches, so quickly that no relevant mains follow currents can flow in the arc.

The surge arrester cam be embodied as any surge arrester known from the prior art, that is, for example, as a varistor, as a suppressor diode and/or as a gas-filled surge arrester or as a spark gap as well as a combination of the aforementioned components. The housing of the overvoltage protection element is preferably embodied in a pressure-resistant manner, that is, preferably embodied such that an increase of the pressure in the housing does not enlarge the volume contained by the housing. Very particularly preferably the housing is embodied of a non-conductive material, such as, for example, a plastic or a metal, that is, preferably conductive. Preferably, the surge arrester and/or the pressure-sensitive switch are connected to the conductors in an electrically conductive manner.

It is very particularly preferred that the pressure-sensitive switch is embodied such that the switch short circuits the electric conductors when a predetermined pressure in the housing is exceeded. The predetermined pressure can thereby be 2%, 5%, 10%, 20% or 50% above the output pressure of the housing. Output pressure means the pressure in the housing that prevails with the application of no voltage or no current at the electrical conductors in the housing. Furthermore, it is preferred that the pressure-sensitive switch can be variably adjusted such that the “reaction” of the switch can be determined according to an adjustable pressure.

According to a further preferred embodiment, it is provided that a lock switch for blocking the switching of the switch is provided, and the lock switch can be unlocked by the increase in pressure and/or by a thermal change in the housing. Furthermore, it is preferred that a spring for acting on the switch is provided with spring force such that the spring actuates the switch after the lock switch is unlocked. The switching operation of the switch on the one hand is accelerated by means of embodiments of this type, that is, due to the spring force acting on the switch due to the spring, and on the other hand is defined such that only with an increase in pressure in the housing and/or due to a thermal change in the housing, that is, for example, due to an increase in temperature, in particular due to an arc, is the lock switch unlocked and thus the switch short circuits the electric conductors so that a preferably upstream overvoltage protection, for example, a fuse, is deployed.

According to a further embodiment it is preferred that a thermal circuit breaker and a spark gap are provided, the thermal circuit breaker is thermally connected to the surge arrester and the thermal circuit breaker is embodied such that the spark gap can be ignited by the thermal circuit breaker. “Thermally connected” hereby means that in the event of an increase of the temperature of the surge arrester, the surge arrester transmits the temperature increase to the thermal circuit breaker, that is, the temperature of the thermal circuit breaker also increases. The thermal circuit breaker can be embodied as any thermal circuit breaker known from the prior art, for example, as a bimetal thermal circuit breaker. An embodiment of the invention of this type ensures that, for example, in the case of a maximum temperature that can be preselected, the thermal circuit breaker switches such that the pressure-sensitive switch is switched due to an arc triggered in a targeted manner or the pressure buildup thereof. The spark gap can thereby for example to build up pressure in the housing have an ignition principle according to DE 101 46 728. It is likewise preferred that the ignition element for the spark gap is embodied according to DE 10 2004 009 072.

Furthermore, according to another embodiment it is very particularly preferred that the switch can be actuated in an irreversible manner. “Irreversible” means that once a switch is switched, it remains in the switched position. In this context it is furthermore preferred that a locking element for locking the switched switch is provided. The locking element can thereby be embodied for example as a locking lug with a corresponding receptacle for the locking lug, known from the art.

According to a further preferred embodiment it is provided that the locking element is embodied such that the locking element locks the switched switch magnetically. The locking element is preferably embodied as a magnetic catch device by means of fixed magnets, as a back blocking spring mechanism and/or by a welding, soldering or fusing of the switch in the switched position or the contacts forming the short circuit. It is achieved by means of such embodiments that the defective or considerably damaged overvoltage element cannot be put into operation again, since the switch locks due to the locking element after being switched once.

In order to indicate the switching of the pressure-sensitive switch, the overvoltage protection element according to an advantageous embodiment of the invention has a device for indicating the switched switch. A device of this type for indication can comprise, for example, a mechanical or optical display device for displaying the condition of the overvoltage protection element. Alternatively or additionally a remote indication for signaling the state of the overvoltage protection element can be provided, to which end then a corresponding change-over contact as a signal generator is embodied preferably on the overvoltage protection element. An optical display device can be formed, for example, by a colored cover or a paint coat or film applied to the housing, the color of which changes depending on the temperature of the housing.

In principle, the switch can be embodied as any pressure-sensitive switch known from the prior art. According to a further embodiment of the invention, however, it is particularly preferred that the switch is embodied as a slide element. Furthermore, it is preferred that the slide element is guided between the conductors or the slide element is guided between a conductor and a wall of the housing. Very particularly preferably the slide element is embodied as a conducting, electrically conductive sealing and/or self back blocking shorting bridge. Furthermore, it is preferred that the slide element is embodied as a sliding, electrically insulating and/or dynamically sealing slide with shorting bridge. By means of embodiments of this type a particularly simple design of the overvoltage protection element or the pressure-sensitive switch can be achieved, wherein, in the event of the explosion of the surge arrester, the slide element can exert an additional dynamically sealing effect for the housing. Very particularly preferred in particular with a housing of a conductive material, insulation is provided between the slide element and the housing. The insulation is preferably embodied of a non-conductive and/or non-combustible material.

According to an advantageous embodiment, a first gas volume is provided in the housing, wherein the first gas volume surrounds the surge arrester and an increase of the pressure of the first gas volume switches the switch. According to a further advantageous embodiment of the invention it is provided that a second gas volume is provided in the housing, the housing has a device for the escape of the second gas volume out of the housing and the switching of the switch increases the pressure of the second gas volume such that the second gas volume escapes out of the housing through the device. The first and/or the second gas volume are preferably embodied as non-compressible and/or non-flammable or non-combustible gases, for example have an inert gas known from the prior art. The device for the escape of the second gas volume is preferably embodied as above as a bore in the housing and/or as an opening.

According to another preferred embodiment it is provided that a thermal disconnector for short circuiting the electric conductor is provided. Disconnectors of this type are known from the prior art, for example from DE 93 05 796 U1 or from U.S. Pat. No. 6,430,019. Furthermore it is preferred that the housing is embodied of metal and an electric conductor is electrically connected to the housing. An embodiment of this type permits a particularly simple and favorable embodiment of the housing

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 shows an overvoltage protection element according to a first exemplary embodiment in a diagrammatic view,

FIG. 2 shows an overvoltage protection element according to a second preferred exemplary embodiment in a diagrammatic view,

FIG. 3 shows an overvoltage protection element according to a third preferred exemplary embodiment in a diagrammatic view,

FIG. 4 shows an overvoltage protection element according to a fourth preferred exemplary embodiment in a diagrammatic view, and

FIG. 5 shows an overvoltage protection element according to a fifth preferred exemplary embodiment in a diagrammatic view.

### DETAILED DESCRIPTION

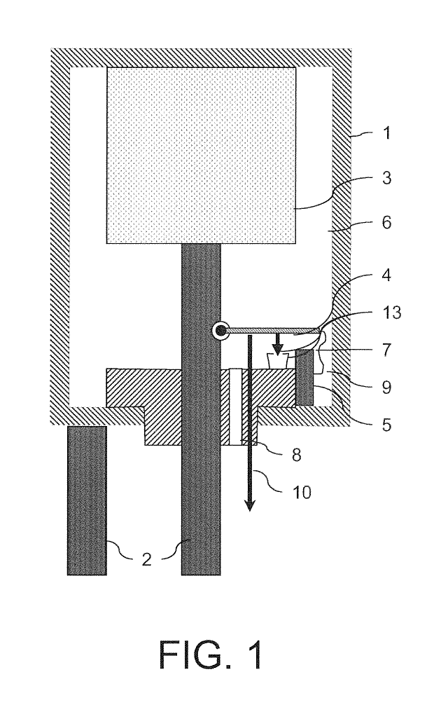

FIGS. 1 through 5 show an overvoltage protection element according to various preferred exemplary embodiments of the invention. The overvoltage protection element has a pressure-resistant housing 1 and two electric conductors 2 leading into the housing 1 for the electrical connection of the overvoltage protection element.

A surge arrester 3 for limiting an overvoltage of the electric conductors 2 as well as a pressure-sensitive switch 4 for short-circuiting the electric conductors 2 are arranged in the housing 1, which according to the preferred exemplary embodiment in FIG. 1 is embodied from a conductive material.

As can be seen from FIGS. 1 through 4, the surge arrester 3 is connected to one of the two electric conductors 2 in an electrically conducting manner as well as to the housing 1 in an electrically conducting manner, wherein the metallic and thus electrically conductive housing 1 in turn is connected to the second electric conductor 2 in an electrical conducting manner. Likewise, the pressure-sensitive switch 4 is electrically connected to one of the two electric conductors 2, wherein a switching contact 5 is provided, which is connected to the electrically conductive housing 1 and thus also to the second electric conductor 2 in an electrically conducting manner. In this case the surge arrester 3 is embodied as a varistor.

In the event of a fault current occurring at the electric conductors 2, which cannot be detected by the surge arrester 3 due to a defective surge arrester 3, for example, due to aging, an arc is produced in the housing 1, which arc leads to an increase in the pressure in the housing 1. In a case of this type, that is, with the non-reaction of a defective surge arrester 3, the increase in pressure in the housing 1 leads to a switching of the pressure-sensitive switch 4, thus to a short-circuiting of the electric conductors 2. Thus an upstream overvoltage protection, not shown, for example, a fuse, can react and switch off the fault current flowing in the conductors 2 or a circuit, not shown, connected to the conductors 2.

According to the shown preferred exemplary embodiments of the invention a first gas volume 6 is provided in the housing 1, which gas volume surrounds the surge arrester 3, and, in the event of an increase in the pressure of the first gas volume 6, switches the switch 4. Furthermore, a second gas volume 7 is provided in the housing 1, wherein with the switching of the switch 4, the second gas volume 7 escapes out of the housing 1 through a device for the escape 8 of the second gas volume 7. The first gas volume 6 and the second gas volume 7 are thereby embodied as non-compressible, non-ignitable or non-combustible gases. The device for the escape 8 of the second gas volume 7, as can be seen from FIG. 1, is embodied as a bore for the equalization of pressure.

A mechanically moveable seal 9 is arranged on the pressure-sensitive switch 4, which seal is provided between the first gas volume 6 and the second gas volume 7. Furthermore, the overvoltage protection element has a device for indicating 10 the switched switch 4, which, for example, can represent the switching of the switch 4 in color on the outside of the housing 1 and/or can notify a telecommunications installation, for example, a monitoring station. In this case the device for indicating 10 the switched switch 4 is embodied as a moveable pin driven by the switching contact of the switch 4.

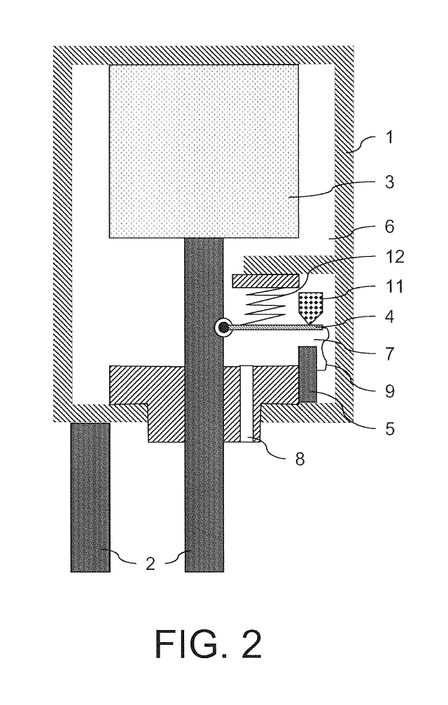

According to a further exemplary embodiment of the invention, as can be seen from FIG. 2, a lock switch 11 is provided for blocking the switching of the switch 4, wherein the lock switch 11 can be unlocked by an increase in pressure in the housing 1 and/or by a thermal change in the housing 1, for example, with the increase in the temperature in the housing 1 caused by an arc produced due to a defective surge arrester. Likewise, a spring 12 is provided for acting on the switch 4 with spring force such that the spring 4 actuates, in particular switches, the switch 4 after the unlocking of the lock switch 11. By a design of this type the switch 4 is thus preloaded by spring force such that when an arc occurs in the housing, the lock switch 11, due to the increase in pressure or increase in temperature produced in the housing 1, unlocks and the switching of the switch 4 due to the spring 12 is carried out in an accelerated manner.

In order to ensure that a short circuit once generated between the two electric conductors 2 is maintained permanently, that is, a faulty overvoltage protection element cannot continue to be used, a locking element 13 for locking the switched switch 4 is provided. The locking element 13 can be embodied as a lock known from the prior art, for example, as shown in the figures, as a magnetic catch by means of fixed magnets or as a back blocking spring mechanism. Likewise possible are a welding, soldering or fusing, caused in a targeted manner, of the contact points forming the short-circuit of the switch 4 by the switching of the switch 4.

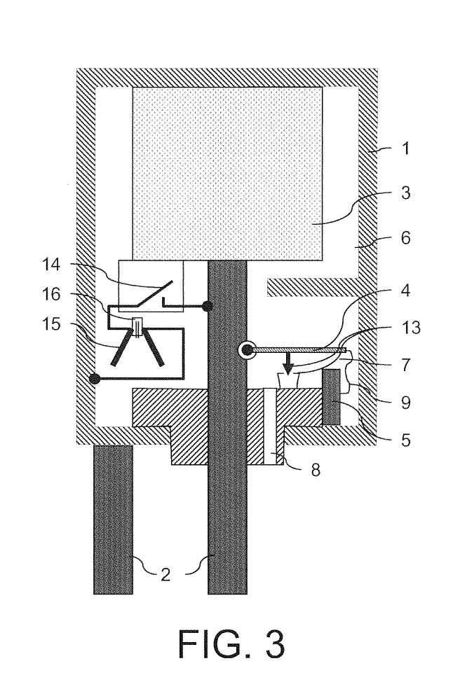

According to the exemplary embodiment of the invention shown in FIG. 3, furthermore a thermal circuit breaker 14 as well as a spark gap 15 are provided in the housing 1. The thermal circuit breaker 14, which is embodied as a bimetal switch, is thermally coupled to the surge arrester 3, so that in the event of a heating, that is, an increase in temperature, of the surge arrester 3, the thermal circuit breaker 14 switches and an ignition element 16, for example, an ignition element 16 as is known from DE 10 2004 009 072, ignites the spark gap 15 so that a pressure increase occurs in the housing 1 and the pressure-sensitive switch 4 short-circuits the electric conductors 2. The spark gap 15 can thereby have an ignition principle according to DE 101 46 728. Thus the pressure in the housing 1 can be increased due to an arc ignited in a targeted manner so that the pressure-sensitive switch 4 switches due to the increased pressure.

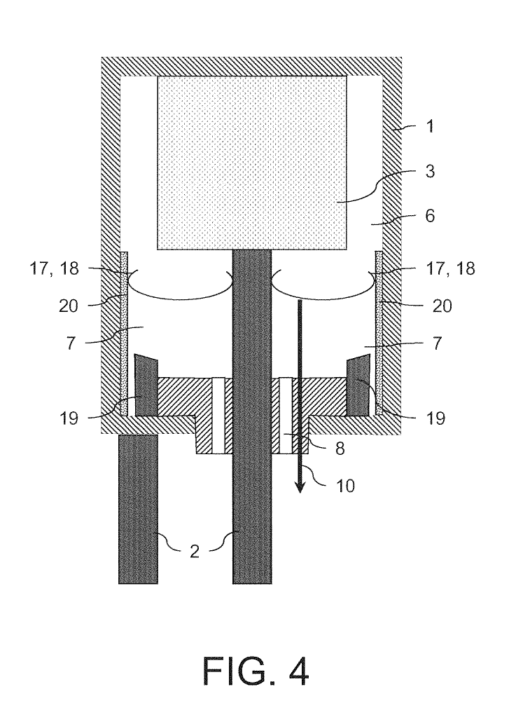

As can be seen from FIG. 4, the pressure-sensitive switch 4 can be embodied as a conducting, electrically conductive, sealing and/or self back blocking slide element 17. In this case the slide element 17 is embodied as a shorting bridge 18, which is guided or slides between a conductor 2 and a wall of the housing 1. If the housing 1 is made of a conductive material, it is preferred, as can be further seen from FIG. 4, to provide an insulation 20 between the slide element 17 and the housing 1. The insulation is preferably embodied of a non-conductive and/or non-combustible material.

With a pressure increase in the housing 1 or the first gas volume 6, the slide element 17, guided by a conductor 2 and the wall of the housing 1, slides in the direction of a switching contact 19, so that a short circuit is produced between the first conductor 2 and the switching contact 19, which is turn is connected to the second conductor 2 in an electrically conducting manner.

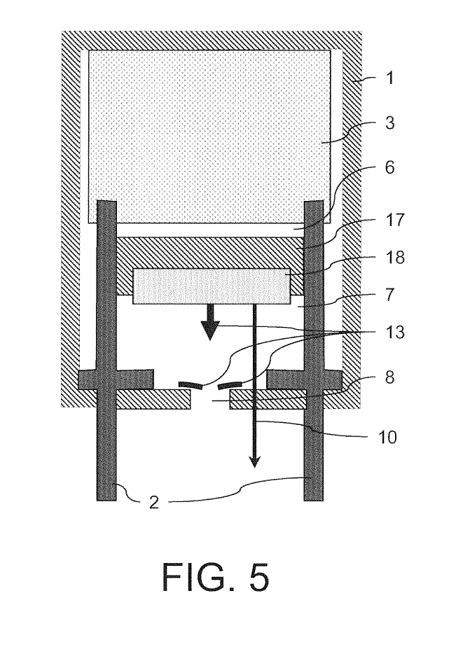

FIG. 5 shows a further preferred exemplary embodiment of the invention with a slidable electrically insulating dynamically sealing slide element 17 with shorting bridge 18. Compared to FIG. 4, where the housing 1 is embodied in an electrically conductive manner and is connected to one of the two conductors 2 in an electrically conductive manner, the housing 1 according to FIG. 5 is embodied of a non-conductive material, for example a plastic.

As a result, an overvoltage protection element is provided, which ensures a reliable cut off of a fault current applied at a conductor 2 in the case of a defective surge arrester 3, even with a high power conversion of the electric conductors 2, in a safe and simple manner. Because an irreversible pressure-sensitive switch 4 for short-circuiting the electric conductors 2 is arranged in the overvoltage protection element, an arc produced in the housing 1 or the pressure increase caused thereby in the housing 1 triggers a switching of the pressure-sensitive switch 4, so that the electric conductors 2 are short circuited and an upstream overvoltage protection, for example, a fuse, is triggered and switches off the fault current in the conductors 2.

What is claimed is:

1. An overvoltage protection element with a housing (1), at least two electric conductors (2) leading into the housing (1) for electrical connection of the overvoltage protection element, a thermal switch (14), a spark gap (15) and an ignition element (16),
wherein arranged in the housing (1) are a surge arrester (3) for limiting an overvoltage of the electric conductors (2) and a pressure-sensitive switch (4) for short circuiting the electric conductors (2),
the thermal switch (14) on the surge arrester (3) is thermally connected, and
the thermal switch (14) is designed such that by switching of the thermal switch (14) the spark gap (15) is ignited by the ignition element (16).

2. The overvoltage protection element according to claim 1, wherein the pressure-sensitive switch (4) is embodied such that the switch (4) short circuits the electric conductors (2) when a predetermined pressure in the housing (1) is exceeded.

3. The overvoltage protection element according to claim 1, wherein a lock switch (11) for blocking the switching of the switch (4) is provided, and the lock switch (11) can be unlocked by the increase in pressure and/or by a thermal change in the housing (1).

4. The overvoltage protection element according to claim 3, wherein a spring (12) for acting on the switch (4) is provided with spring force such that the spring (12) actuates the switch (4) after the lock switch (11) is unlocked.

5. The overvoltage protection element according to claim 1, wherein a thermal circuit breaker (14) and a spark gap (15) are provided, the thermal circuit breaker (14) is thermally connected to the surge arrester (3) and the thermal circuit breaker (14) is embodied such that the spark gap (15) can be ignited by the thermal circuit breaker (14).

6. The overvoltage protection element according to claim 1, wherein the switch (4) can be switched in an irreversible manner.

7. The overvoltage protection element according to claim 1, wherein a locking element (13) for locking the switched switch (4) is provided.

8. The overvoltage protection element according to claim 7, wherein the locking element (13) is embodied such that the locking element (13) locks the switched switch (4) magnetically.

9. The overvoltage protection element according to claim 1, wherein a device for indicating (10) the switched switch (4) is provided.

10. The overvoltage protection element according to claim 1, wherein the switch (4) is embodied as a slide element (17).

11. The overvoltage protection element according to claim 10, wherein the slide element (17) is guided between the conductors (2) or the slide element (17) is guided between a conductor (2) and a wall of the housing (1).

12. The overvoltage protection element according to claim 1, wherein a first gas volume (6) is provided in the housing (1), the first gas volume (6) surrounds the surge arrester (3) and an increase of the pressure of the first gas volume (6) switches the switch (4).

13. The overvoltage protection element according to claim 1, wherein a second gas volume (7) is provided in the housing, the housing (1) has a device for the escape (8) of the second gas volume (7) out of the housing (1) and the switching of the switch (4) increases the pressure of the second gas volume (7) such that the second gas volume (7) escapes out of the housing (1) through the device (8).

14. The overvoltage protection element according to claim 1, wherein a thermal disconnector for short circuiting the electric conductors (2) is provided.

15. The overvoltage protection element according to claim 1, wherein the housing (1) is embodied of metal and an electric conductor (2) is electrically connected to the housing (1).
